(19) United States
(12) Patent Application Publication
(10) Pub. No.: US 2009/0094607 A1
(43) Pub. Date: Apr. 9, 2009

(54) PROCESSING REQUEST CONTROL DEVICE, RECORDING MEDIUM STORING PROGRAM, PROCESSING REQUEST CONTROL METHOD AND DATA SIGNAL

(75) Inventor: Shigeo INDEI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/139,867

(22) Filed: Jun. 16, 2008

(30) Foreign Application Priority Data
Oct. 5, 2007 (JP) 2007-262146

(51) Int. Cl. G06F 9/46

(52) U.S. Cl. 718/102

(57) ABSTRACT

A processing request control device, which includes: a reception section that receives a processing request and information on a property of the processing request; a calculation section that calculates a processing time zone based on the processing request; a management section that manages the processing request and the processing time zone associated with each other; a processing implementation control section that controls to implement, based on the processing request, the processing from a processing start time; a specification section that, when a new processing request is received, specifies a processing request being managed whose processing time zone overlaps with a processing time zone of the newly received processing request; and a change section that changes at least one of the processing time zone of the specified processing request and that of the new processing request within a range based on the properties of the processing request.

### CROSS-REFERENCE TO RELATED APPLICATION

This application is based on and claims priority under 35 USC 119 from Japanese Patent Application No. 2007-262146 filed on Oct. 5, 2007.

### BACKGROUND

### Technical Field

The present invention relates to a processing request control device, a recording medium storing a program, a processing request control method and a data signal.

### SUMMARY

An aspect of the present invention provides a processing request control device, which includes a reception section that receives a processing request and information related to a property of the processing request; a calculation section that calculates a processing time zone of a processing based on the processing request; a management section that manages the processing request and the processing time zone of the processing request calculated by the calculation section in association with each other; a processing implementation control section that controls to implement, based on the processing request managed by the management section, the processing from a processing start time according to the processing time zone; a specification section that, when a new processing request is received, specifies a processing request being managed by the management section whose processing time zone overlaps with at least a portion of a processing time zone of the newly received processing request; and a change section that changes at least one of the processing time zone of the processing request specified by the specification section and the processing time zone of the new processing request within a range based on the property of the processing request.

### BRIEF DESCRIPTION OF THE DRAWINGS

An exemplary embodiment of the present invention will be described in detail based on the following figures, wherein:

FIG. 1 is a diagram illustrating an overview of a job input processing in a printing system to which the present invention is applied;

FIG. 2 is a diagram illustrating one example of a first interference avoidance processing;

FIG. 3 is a diagram illustrating one example of a second interference avoidance processing;

FIG. 4 is a diagram illustrating one example of a third interference avoidance processing;

FIG. 5 is a diagram illustrating one example of a fourth interference avoidance processing;

FIG. 6 is a block diagram illustrating a configuration of a user terminal and a printing device in the printing system shown in FIG. 1;

FIG. 7 is a functional block diagram for implementing the interference avoidance processing in the printing device;

FIG. 8 is a diagram illustrating one example of management information related to each printing job registered in a job list;

FIG. 9 is a flow chart illustrating a procedure for input processing of the printing job; and

FIGS. 10A to 10C are diagrams illustrating example screens for job input operation for designating a processing time zone.

### DETAILED DESCRIPTION

An exemplary embodiment of the present invention will be described with reference to the attached drawings.

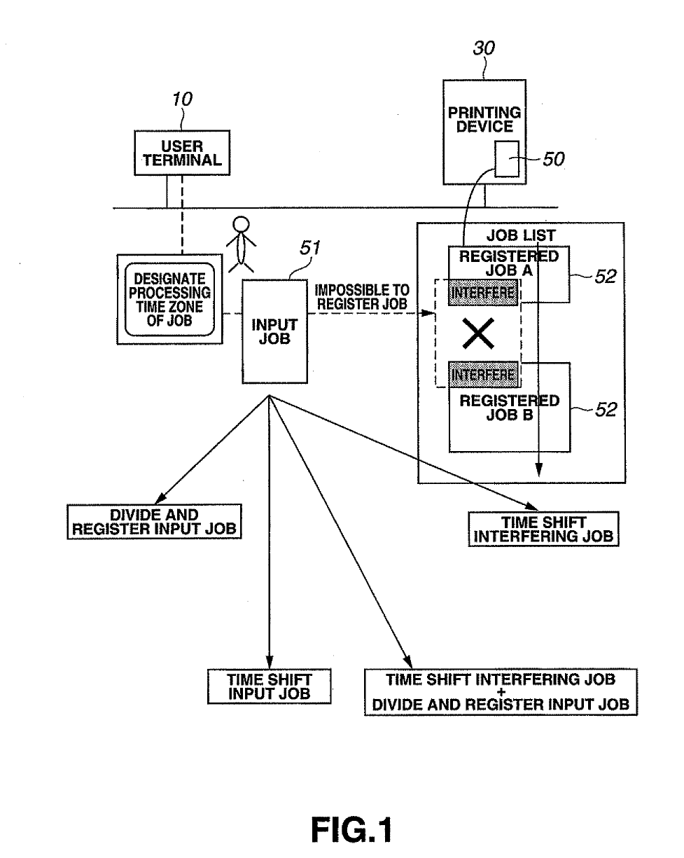

FIG. 1 is a diagram illustrating an overview of a job input processing in a printing system to which the present invention is applied

A “job” herein refers to a request for processing, which includes a time for starting the processing (processing start time) or a time for ending the processing (processing ending time). Printing or other processing is implemented based on the request.

Through a registration screen for a job displayed on a display 13 in a user terminal 10, a user implements input operation for a job 51 to register it in a printing device 30.

In this time, the user designates either of the processing start time or the processing ending time for the job to be inputted.

Once the job is inputted to the printing device 30, an expected processing ending time when the processing start time is designated, or an expected processing start time when the processing ending time is designated is estimated, and a processing time zone is specified.

Then, the processing time zone is registered in a job list 50 so as to be associated with the job.

The job list 50 is a list for managing jobs, and will be described in detail later.

At this time, there may occur a case where there exists an interfering registered job 52 in which at least a portion of a processing time zone of a job already registered in the job list 50 overlaps with at least a portion of a processing time zone of the inputted job 51 that is designated by the user through the job registration screen.

A printing system has a function of setting an acceptable range within which the designated time information is changeable at the time of registering the job to the job list 50 or after the job is registered in the job list 50. The printing system also has a setting function for performing a processing (hereinafter, “time shift” or “shift”) of changing, as appropriate, the processing start time for the job earlier or later within the set acceptable range.

In other words, even if time information related to a processing based on the job is designated for the job, the designated time information can be changed depending on property of the job. Additionally, since the acceptable range for the change varies depending on the property of the job, the printing system has the function of setting the acceptable range.

Furthermore, the printing system has a function of dividing the inputted job 51 into plural jobs at each prescribed processing (e.g. at each printing page) and registering each of the divided jobs between jobs already registered in the job list 50, and provides a setting function for avoiding an interference registration by the job division registeration in which the user selects and designates an enabling or disabling of the division registration function of the job through the operation screen for job registration.

Upon receiving the newly inputted job 51 from the user terminal 10, the printing device 30 calculates a processing time zone of the newly inputted job and determines whether or not the processing time zone of the job already registered in the job list 50 interferes with the processing time zone calculated for the newly inputted job, based on the processing start time or processing ending time designated for the inputted job 51 and a size of the inputted job.

If there exists any interfering job 52 registered in the job list 50, the printing device 30 performs the following avoidance processings to determine whether or not the interference is avoidable.

As a first interference avoidance processing, there is an interference avoidance processing in which the processing time zone of the inputted job is shifted within a set acceptable range.

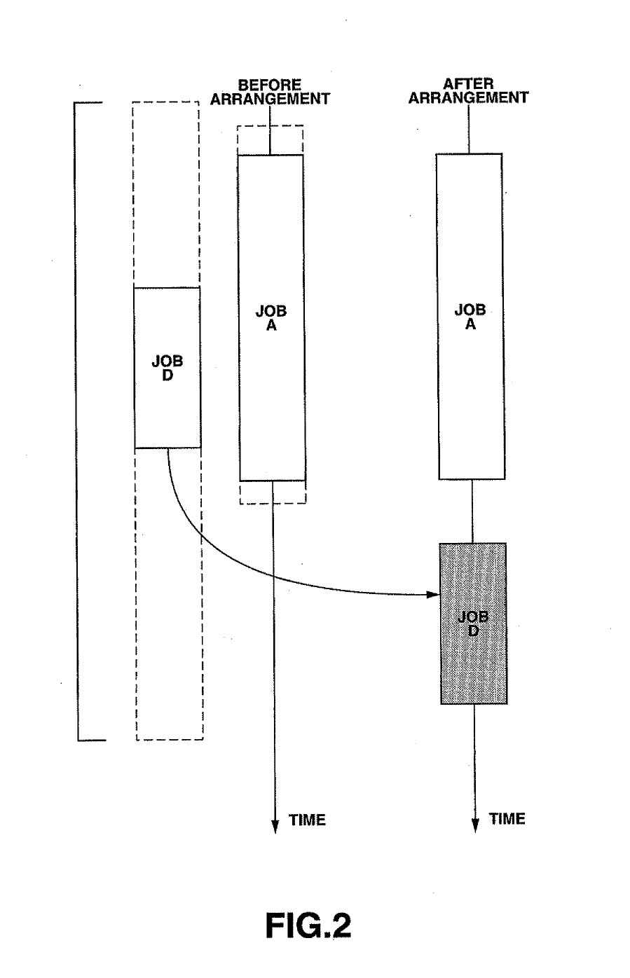

FIG. 2 illustrates a processing time zone of each job.

Although a job D is to be registered with a designated start time, the inputted job D interferes with a processing time zone of a job A.

Dotted lines in FIG. 2 illustrate a range where change in processing time zone for each of the jobs is permitted.

In this example, by delaying the processing start time of the job D, overlapping (interference) of the processing time zone of the job D with the processing time zone of the job A is avoidable. Thus, after the processing time zone of the job D is changed as described above, the registration to the job list 50 is performed.

Next, as a second interference avoidance processing, there is an interference avoidance processing in which time of an interfering job that is already registered is shifted within a set acceptable range.

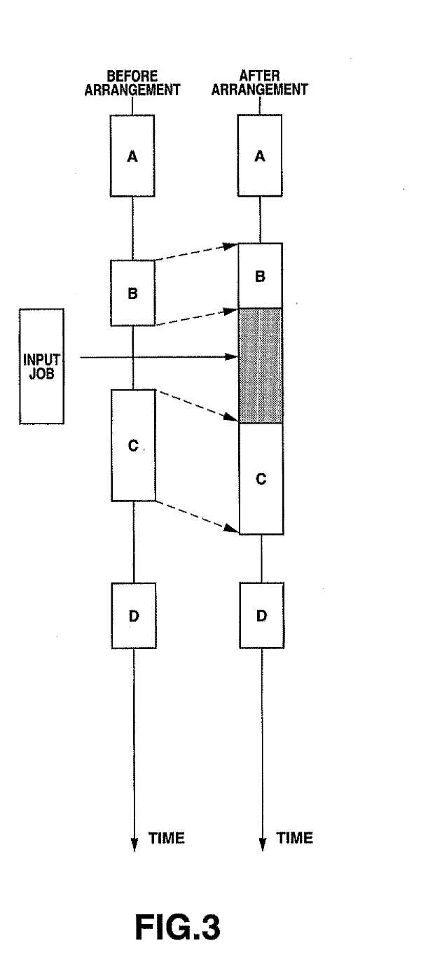

As shown in FIG. 3, if a job is inputted with a designated processing time zone, the processing time zone of the inputted job partly interferes with processing time zones of a job B and a job C.

It is assumed that, for the inputted job, as the time-shift within the acceptable range is not set or permission for the time-shift is not designated, the inputted job cannot be registered outside the designated processing time zone.

On the other hand, it is assumed that, for each of the interfering job B and job C, which are already registered, the time-shift within the acceptable range is permitted.

In this case, the job B is shifted to earlier than the designated processing time zone, while the job C is shifted to later than the designated processing time zone, whereby a time zone where no job is registered is obtained for registering the inputted job.

Next, as a third interference avoidance processing, there is an interference avoidance processing in which an inputted job is divided, and each of the divided jobs is registered.

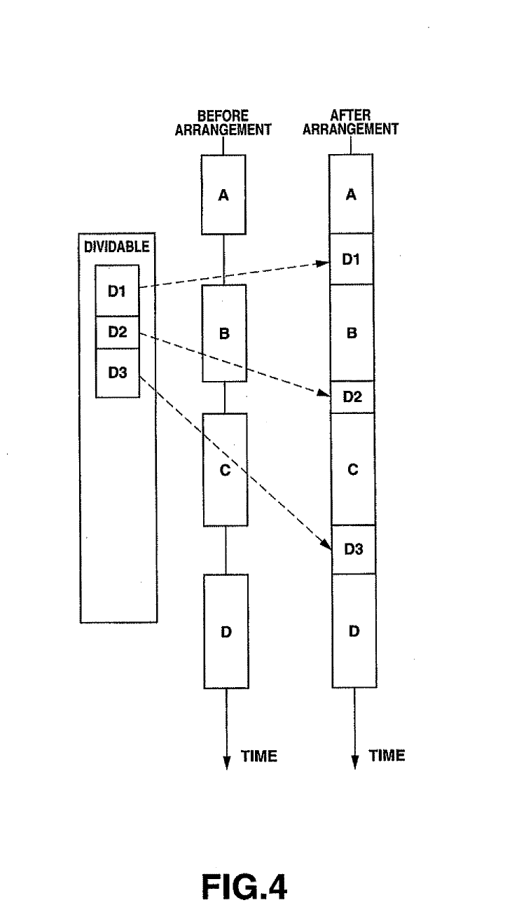

It is assumed that, as shown in FIG. 4, an inputted job D can be divided, for example, at prescribed printing pages into three jobs (a job D1, a job D2 and a job D3) and the division registration for the job within the acceptable range that is designated by the user is permitted.

On the other hand, it is also assumed that the time-shift after the registration is not permitted for a job B, a job C and a job E. Processing time zones of the job C and the job E are registered before or after the job B.

In this case, the divided job D1 is registered before the processing start time of the job B and within the acceptable range of the job D. The divided job D2 is registered at a processing time zone located between the processing ending time of the job B and the processing start time of the job C, where no job is registered. Then, the divided job D3 is registered at a processing time zone between the processing ending time of the job C and the processing start time of the job E, where no job is registered.

Next, as a fourth interference avoidance processing, there is a processing in which the time-shift processing of the interfering registered job as shown in the second interference avoidance processing is combined with the interference avoidance processing employing the division registration for the inputted job as shown in the third interference avoidance processing.

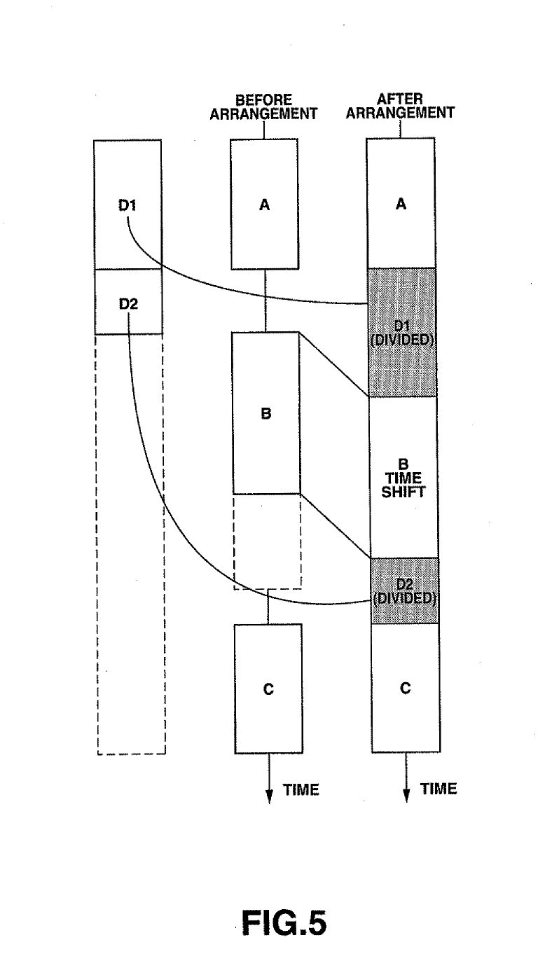

It is assumed that, as shown in FIG. 5, an acceptable range for the processing time zone to be registered is set for an inputted job D, and division registration with plural jobs is permitted.

Furthermore, it is assumed that the time-shift after registration is not permitted for a job A, and the time-shift for a job B is permitted.

Before arrangement is made, the processing time zone of the inputted job D interferes with the processing time zone of the job A.

At this time, even if the job B is shifted up to the maximum acceptable range in a direction of delaying the processing start time of the job B, the processing time zone where the inputted job D is registered without interfering cannot be obtained. However, as the inputted job D is allowed to be divided, a processing time zone for registering a job D1, which is one of the jobs made by dividing the job D, can be obtained.

Additionally, a job D2, which is the rest of the divided job D, can be registered at a processing time zone located between the job B after the time-shift and the job C that is not permitted to be shifted, where no registered job exists.

Thus, as shown in a diagram after the arrangement in FIG. 5, the divided job D1 is registered at a time-zone located between the processing ending time of the job A and the processing start time of the job B after the time-shift, and the divided job D2 is registered at a time-zone after the shifted processing ending time of the job B and within the acceptable range designated for the job D.

In a case where the interference of the job cannot be avoided even if all the interference avoidance processings as described above are applied, there is provided a designation time re-inputting function in which the operation screen for prompting the user to change the designated time of the inputted job is displayed on a display 13.

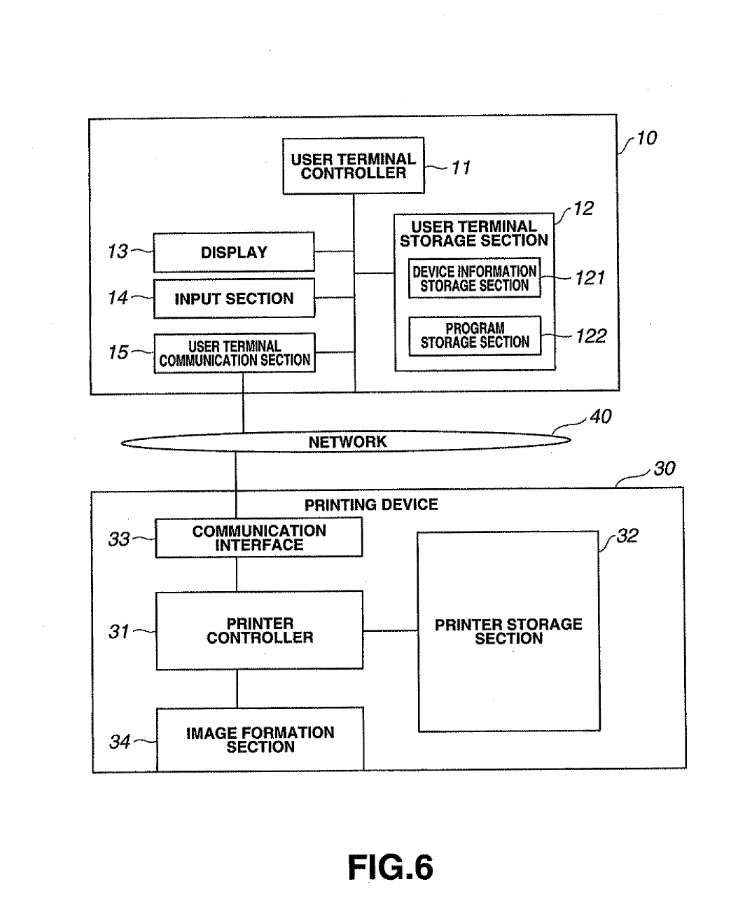

Next, shown in a block diagram in FIG. 6, one example of configurations of the user terminal 10 and the printing device 30 as shown in FIG. 1 will be described.

In FIG. 6, the user terminal 10 is provided with a user terminal controller 11. The user terminal controller 11 is connected with a user terminal communication section 15, an input section 14, a display 13 and a user terminal storage section 12.

The user terminal controller 11 includes a CPU (Central Processing Unit), a RAM (Random Access Memory), loads various controlling programs stored in a program storage section 122 in the user terminal storage section 12 to the RAM to execute them, and controls the overall user terminal 10.

The user terminal communication section 15 performs a transmission/receipt of control information with the printing device 30 connected through a network 40, and outputs a job.

The input section 14 is formed by an input device such as a keyboard and a mouse, and the user performs inputting operation through the input section 14.

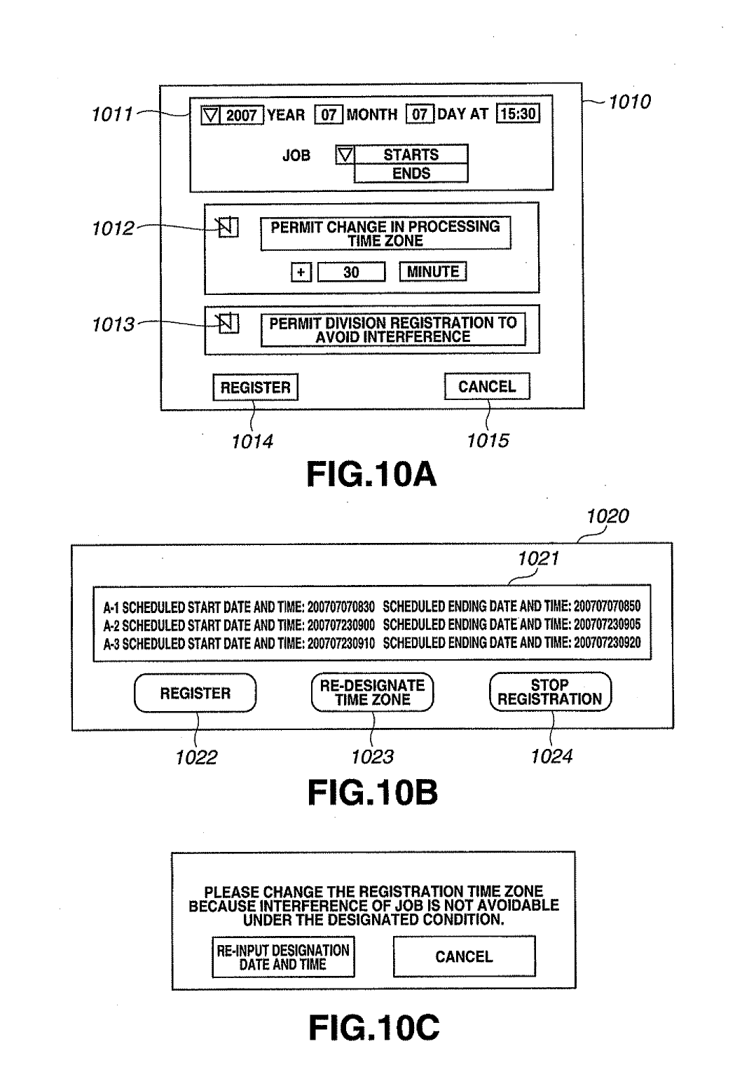

The display 13 is, for example, a liquid crystal display and so on, and is a device for displaying information including operation screens as shown in FIGS. 10A through 10C as a user interface for performing printing operation.

FIGS. 10A through 10C show screens for performing job inputting operation.

A job registration screen 1010 includes: a processing time zone inputting section 1011 for inputting a processing start/ending time of a job at the time when a processing time zone is designated and printing is scheduled; a processing time zone changing acceptable range inputting section 1012 for inputting an acceptable range when time-shift is permitted for the job that interferes at the time of inputting; and a division registration instruction inputting section 1013 for inputting permission for division registration in a case where interference of the job to be registered with the registered job is avoidable by dividing the job to be registered and registering the divided job to the job list 50.

If the checkbox for permission to change the processing time zone is checked, an input area for inputting the acceptable time in the processing time zone changing acceptable range inputting section 1012 becomes available for the user to input a time range shiftable at the time of job registration or after the job registration to the job list 50. The time range is inputted by prescribed unit time while the designated processing time is set to a starting point.

For example, if it is permitted to change the time zone up to 60 minutes forward from the designated time, “−60 minutes” is inputted. On the other hand, if it is permitted to change the time zone up to 30 minutes backward from the designated time, “+30 minutes” is inputted. If it is permitted to shift the time zone up to 60 minutes forward and backward from the designated processing start/ending time, “±60 minutes” and so on are designated.

It may be possible to separately set the acceptable range for the time-shift in each of the forward and backward direction, and to provide “no limitation” and so on to be selected as appropriate in a case where no particular limitation is set for each of the changing directions.

FIG. 10B shows a job registration time zone confirmation screen 1020. The job registration time zone confirmation screen 1020 includes a job registration time zone displaying section 1021 for notifying the user of an avoidable processing time zone for a job when interference occurs for the job. The user is prompted to select any one of registration of the job with a displayed time, re-input of other designation time and stop of the job registration.

FIG. 10C is a screen for notifying that the interference is not avoidable. This notification screen is shown when the interference cannot be avoided under a condition designated by the user through the job registration screen even if all of the interference avoidance processings shown in FIGS. 2 through 5 are performed. The notification screen prompts the user to select the re-input operation of a job with a processing time zone through a processing time zone re-input button 1031 or an operation for canceling job registration through a processing stop button 1032.

Return to FIG. 6.

A device information storage section 121 stores and manages IP addresses of devices on the network 40 and information for determining whether or not each of the devices has a function of schedule printing through designating a printing time.

A program storage section 122 stores various programs executed by the CPU in the user terminal controller 11.

In FIG. 6, the printing device 30 has a configuration in which a printer controller 31, a printer storage section 32, a communication interface 33 and an image formation section 34 are connected.

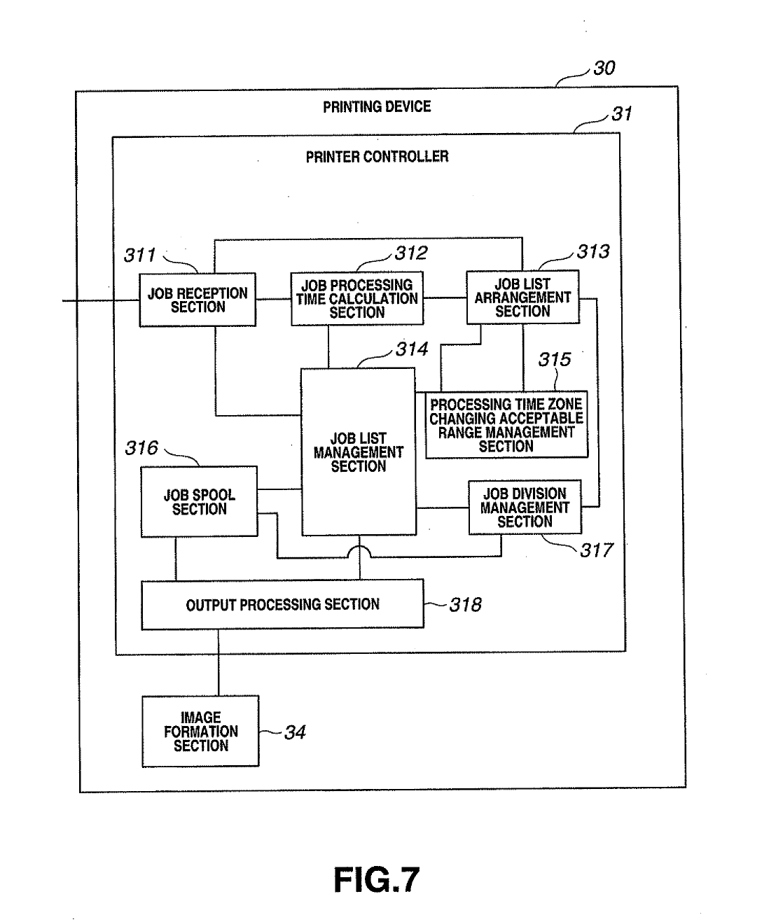

Next, shown in the diagram in FIG. 7, a functional block diagram for avoiding job interference in the printing device shown in FIGS. 1 and 6 will be described.

The printer controller 31 includes the CPU and the RAM. The CPU loads a controlling program to the RAM and executes the loaded program, whereby the printer controller 31 functions as a job reception section 311, a job processing time calculation section 312, a job list arrangement section 313, a job list management section 314, a processing time zone changing acceptable range management section 315, a job spool section 316, a job division management section 317, an output processing section 318 and the job list 50.

It should be noted that the controlling program can be provided by being stored in a computer readable medium, such as CD-ROM or DVD-ROM, or can be provided through communication means.

The job reception section 311 has a function of temporarily storing a job generated by the input operation through an operation screen on the display 13 until the job is registered in the job spool section 316. In cooperation with the job processing time calculation section 312, the job reception section 311 notifies a job requester whether or not the inputted job can be processed by a designated time, and that there exists a registered job interfering with the inputted job if the interfering registered job is found as a result of determination whether there exists any interference at the time when the job is registered with a processing start time designated by the user through a printing operation screen. Through the notification function, the user is prompted to determine the necessity of performing the processing.

The job processing time calculation section 312 analyzes the contents of the job stored in the job reception section 311, calculates a time period required for printing processing based on the number of the printing pages or printing setting information, and obtains the processing ending time of the job based on the calculation result.

At this time, in cooperation with the job list management section 314, the job processing time calculation section 312 searches a registered job whose processing start time overlaps with the printing processing time zone (time period between the processing start time and the processing ending time) of the job stored in the job reception section 311. If there exists any overlapping job, the job processing time calculation section 312 notifies the job reception section 311 of information on the overlapping job.

Additionally, for the inputted job received by the job reception section 311, the job processing time calculation section 312 determines whether or not there exists any designation of an acceptable range within which the processing start time or processing ending time of the job can be shifted. If the acceptable range is set, the job processing time calculation section 312 determines whether or not the job interference is avoidable by shifting the job processing time zone within the acceptable range.

The job list arrangement section 313 shifts the processing start time such that the job is processed within the acceptable range and within the time zone where the interference can be avoided, and notifies the job reception section 311 of the processing start time after the shift. Then, the job list arrangement section 313 updates the job processing start time and processing ending time in the job list 50 to those after the shift.

Additionally, when determining that the interference of the job is not avoidable even if the processing time zone is shifted within the acceptable range, the job list arrangement section 313 requests the job division management section 317 to divide the inputted job.

The processing time zone changing acceptable range management section 315 calculates the total processing time of each of the jobs based on the time-shiftable acceptable time for each of the processing start time and processing ending time in each of the jobs.

Additionally, when the printing job is divided, the processing time zone changing acceptable range management section 315 calculates a total processing time for each of the divided jobs, and obtains the processing start time of a first job that is scheduled to be processed first in the divided jobs and the processing ending time of a last job that is scheduled to be processed last in the divided jobs.

The job list management section 314 records a processing schedule for each of the registered jobs in the job list 50 and manages it. The job list management section 314 records a processing start time registered by the user; setting information for specifying an acceptable range when the acceptable range is designated; a processing start time and processing ending time indicating a time zone after being changed when the processing time zone is changed by the interference avoidance control performed after the job is registered; and identification information of the related job when the job is divided and registered by the interference avoidance processing.

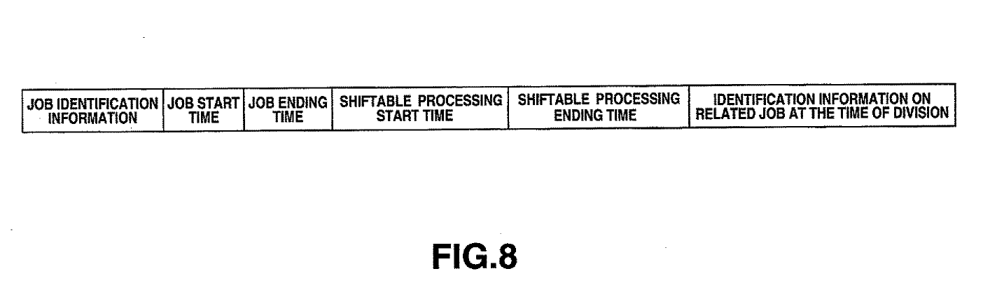

As shown in FIG. 8, the job list 50 includes, for example, job identification information, a job start time, a job ending time, an earliest acceptable processing start time, a latest acceptable processing ending time, and identification information of a related job when the job is divided and registered.

Return to a block diagram in FIG. 7.

In cooperation with the job list arrangement section 313 and the job list management section 314, the job division management section 317 divides the job temporarily stored in the job reception section 311, and registers the divided jobs to the job spool section 316.

The job spool section 316 spools the job managed by the job list management section 314, registers information on the spooled job in the job list 50, manages the registered information and maintains it until the processing start time.

The output processing section 318 analyzes the job managed by the job spool section 316 in the order of processing start time to generate printing data, and outputs the generated printing data to the image formation section 34.

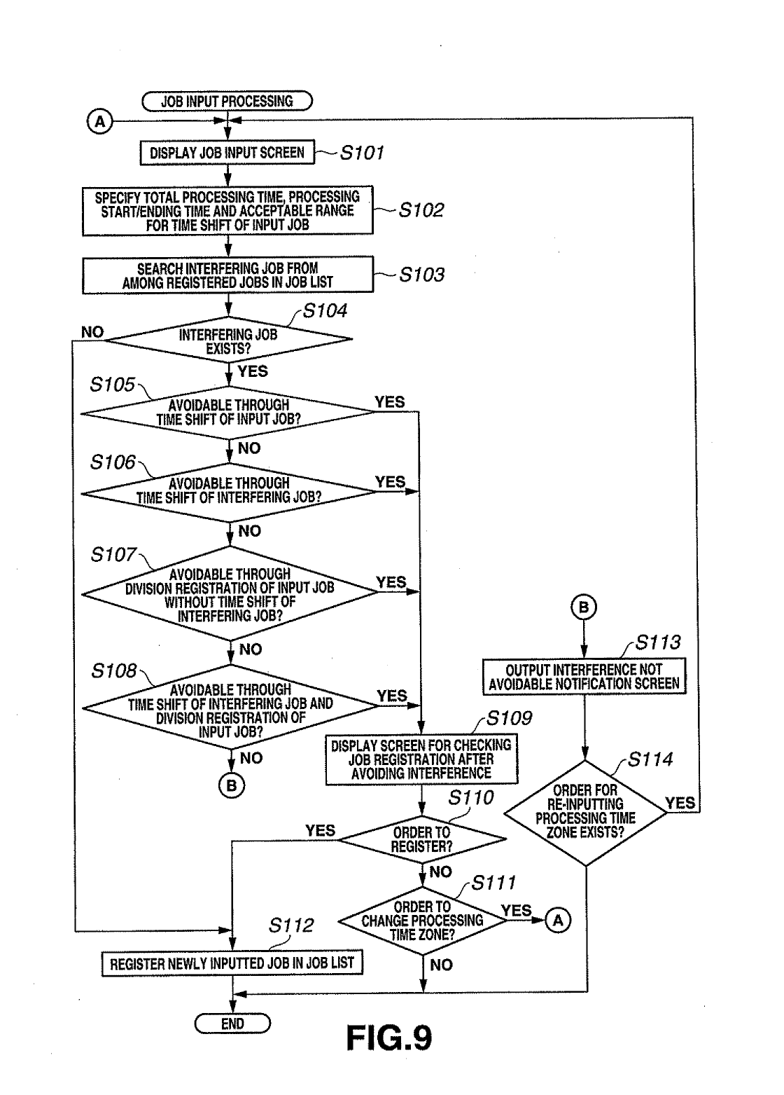

Next, shown in a flow chart in FIG. 9, an operation of job inputting processing including a job interference avoidance processing will be described.

The job registration screen 1010 is outputted to the display 13 (S101). Upon the job registration start button 1014 being depressed, information on a processing time designated by the user through the job registration screen 1010 and details of the received job are analyzed; a total processing time of the job is calculated; the designated processing start time/processing ending time and a processing time zone that is registered with the calculated total processing time are obtained; and permission/refusal of division registration and the acceptable range time for time-shift after being registered are acquired (S102).

Next, the printer controller 31 determines whether or not there exists any job 52 interfering with the processing time zone of the inputted job obtained in step S102 based on a processing time zone specified by the processing start time and the processing ending time of each of the jobs registered in the job list 50 (S103).

If there exists the interfering registered job (YES in S104), the printer controller 31 determines; whether the interference is avoidable by shifting the processing time zone of the inputted job within the designated acceptable range (S105); whether the interference is avoidable by shifting the processing time zone of the registered job interfering with the processing designated time zone of the inputted job 51 within an acceptable range set for the registered job (S106); whether the interference is avoidable by dividing the inputted job, and registering each of the divided jobs to a time zone where no job is registered within the designated time zone for the inputted job (S107); and, whether the interference is avoidable by shifting the processing time zone of the interfering registered job within the acceptable range, and dividing the inputted job to register each of the divided jobs to a time zone where no job is registered in the job list 50 after the time-shift (S108). If the interference can be avoided by any of the determination processings above, the printer controller 31 provides a printer driver 111 of the user terminal 10 with an instruction to output the registration time zone of the inputted job 51 determined through the interference avoidance processing to the display 13 of the user terminal 10 as the job registration time zone confirmation screen 1020 (S109).

Upon receiving from the printer driver 111 notification that job registration with the time zone displayed on the job registration time zone confirmation screen 1020 is instructed (YES in S110), the printer controller 31 registers information including the processing time zone of the inputted job 51 to the job list 50 (S112).

If the printer controller 31 does not receives from the printer driver 111 the notification that the job registration with the time zone displayed on the job registration time zone confirmation screen 1020 is instructed (NO in S110) and re-input instruction operation for the processing time zone is not made (NO in S111), the printer controller 31 stops the job inputting processing.

On the other hand, if the re-input instruction operation for the processing time zone is made through the job registration time zone confirmation screen 1020 (YES in S112), processing returns to step S101 and then the job registration screen 1010 for re-inputting the processing time zone is outputted to the display 113.

On the other hand, if the processing time zone for the inputted job interferes with the processing time zone of the job registered in the job list 50 (YES in S104) and the interference cannot be avoided by any of the interference avoidance processings above (NO in step S108), the printer controller 31 gives an instruction to display to the display 113 an interference not-avoidable notification screen 1030 for notifying the user that the interference is not avoidable (S113).

If an instruction operation to re-input the processing time zone is made through the interference not-avoidable notification screen 1030 (YES in S114), the job registration screen 1010 for re-inputting the processing time zone is outputted to the display 113.

If an operation to stop the job inputting processing is made through the interference not-avoidable notification screen 1030 (NO in S114), the job inputting processing is stopped and the process ends.

The processing request control device, the recording medium storing a program, the processing request control method and the data signal according to the present invention may be applicable to a printing system that controls implementation of a job through designating a processing start time and a processing ending time, and especially be effective to avoid the interference between jobs within a range based on a property of the job.

The foregoing description of the exemplary embodiment of the present invention is provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing request control device, comprising:
a reception section that receives a processing request and information related to a property of the processing request;
a calculation section that calculates a processing time zone of a processing based on the processing request;
a management section that manages the processing request and the processing time zone of the processing request calculated by the calculation section in association with each other;
a processing implementation control section that controls to implement, based on the processing request managed by the management section, the processing from a processing start time according to the processing time zone;
a specification section that, when a new processing request is received, specifies a processing request being managed by the management section whose processing time zone overlaps with at least a portion of a processing time zone of the newly received processing request; and
a change section that changes at least one of the processing time zone of the processing request specified by the specification section and the processing time zone of the new processing request within a range based on the property of the processing request.

2. The processing request control device according to claim 1, wherein
the change section divides the new processing request into a plurality of processing requests, and changes a processing time zone of each of the plurality of processing requests within a range based on a property of the new processing request.

3. A computer readable recording medium storing a processing request control program that causes a computer to execute a process, the process comprising:
receiving a processing request and information related to a property of the processing request;
calculating a processing time zone of a processing based on the processing request;
managing the processing request and the calculated processing time zone of the processing request in association with each other;
controlling to implement the processing from a processing start time according to the processing time zone based on the managed processing request;
when a new processing request is received, specifying a processing request being managed whose processing time zone overlaps with at least a portion of a processing time zone of the newly received processing request; and
changing at least one of the processing time zone of the specified processing request and the processing time zone of the new processing request within a range based on the property of the processing request.

4. A processing request control method, comprising:
receiving a processing request and information related to a property of the processing request;
calculating a processing time zone of a processing based on the processing request;
managing the processing request and the calculated processing time zone of the processing request in association with each other;
controlling to implement the processing from a processing start time according to the processing time zone based on the managed processing request;
when a new processing request is received, specifying a processing request being managed whose processing time zone overlaps with at least a portion of a processing time zone of the newly received processing request; and
changing at least one of the processing time zone of the specified processing request and the processing time zone of the new processing request within a range based on the property of the processing request.

5. A computer data signal embodied in a carrier wave for enabling a computer to perform a process for controlling processing request, the process comprising:
receiving a processing request and information related to a property of the processing request;
calculating a processing time zone of a processing based on the processing request;
managing the processing request and the calculated processing time zone about the processing request in association with each other;
controlling to implement the processing from a processing start time according to the processing time zone based on the managed processing request;
when a new processing request is received, specifying a processing request being managed whose processing time zone overlaps with at least a portion of a processing time zone of the newly received processing request; and
changing at least one of the processing time zone of the specified processing request and the processing time zone of the new processing request within a range based on the property of the processing request.
